(19) United States
(12) Patent Application Publication
(10) Pub. No.: US 2010/0026841 A1
(43) Pub. Date: Feb. 4, 2010

(54) METHODS AND APPARATUSES FOR PROVIDING PHOTOGRAPHING INFORMATION IN DIGITAL IMAGE PROCESSING DEVICE

(75) Inventor: Jun-kwon Choi, Suwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Digital Imaging Co., Ltd., Suwon-si (KR)

(21) Appl. No.: 12/511,222

(22) Filed: Jul. 29, 2009

(30) Foreign Application Priority Data
Aug. 1, 2008 (KR) 10-2008-0075580

(51) Int. Cl. H04N 5/76

(52) U.S. Cl. 348/231.2; 348/E05.031

(57) ABSTRACT

Provided is methods and apparatuses for providing photographing information in a digital image processing device in which photographing information is classified and stored when an image is photographed, and the photographing information is provided to a user according to a user's request, so that a user's may know their photographing pattern. The photographing information may include the type of lens used when an image is photographed and the accumulated number of times the lens has been used when an image is photographed.

### CROSS-REFERENCE TO RELATED PATENT APPLICATION

This application claims the benefit of Korean Patent Application No. 10-2008-0075580, filed on Aug. 1, 2008 in the Korean Intellectual Property Office, the entire contents of which is incorporated herein by reference.

### FIELD OF THE INVENTION

The present invention relates to a digital image processing apparatus and method, and more particularly, to methods and apparatuses for providing photographing information in a digital image processing device.

### BACKGROUND OF THE INVENTION

Some digital image processing devices store photographs as an image file in accordance with an exchangeable image file format (Exif). Users of digital image processing device often review their photographs. But, the information provided with the photograph is often limited and may provide little or no aid to the photographer for improving their photographing skills.

Therefore, there is a need in the art to provide more information to a photographer regarding their photographs to aid the photographer.

### SUMMARY OF THE INVENTION

The present invention provides methods and apparatuses for providing photographing information in a digital image processing device in which photographing information is classified and stored when an image is photographed, and the photographing information is provided to a user according to a user's request, so that a user's photographing pattern can be known.

In embodiments, an apparatus is provided comprising: a digital signal processing unit configured to classify and store photographing information with a photographed image, and configured to search the photographing information according to a user's request, and configured to output the photographing information satisfying the user's request, wherein the photographing information is generated by the apparatus and indicative of the conditions under which the photographed image was captured.

The photographing information may include at least one of: a date and time when an image is photographed, an image size, a photographing mode, a sensitivity, an exposure time, a focal length, a numerical number of an opening of an aperture, and whether a flash is used, and wherein the photographing information is recorded in a predetermined area.

The digital signal processing unit may comprise: a photographing information obtaining unit configured to obtain the photographing information when the image is photographed, and configured to classify the obtained information; a memory configured to store the classified photographing information; and a photographing information outputting unit configured to search the classified photographing information stored in the memory for photographing information satisfying a user's request and configured to output the photographing information satisfying the user's request.

The information obtaining unit may be configured to count the number of accumulated photographs taken and configured to include the accumulated number of photographs with the obtained information.

The information outputting unit may be configured to provide a main menu having items corresponding to the classified photographing information and configured to provide a sub-menu corresponding to a main menu item, wherein the selection of a sub-menu by the user outputs information satisfying the user's request.

In embodiments, an apparatus is provided comprising: a photographing unit configured to store photographing information regarding exchangeable lenses; and a digital signal processing unit configured to receive the photographing information regarding exchangeable lenses from the photographing unit, and configured to classify the photographing information, and configured to search the photographing information according to a user's request, and configured to output the photographing information matching the user's request.

The photographing information further includes at least one of a date and time when an image is photographed, an image size, a photographing mode, sensitivity, exposure time, a focal length, a numerical number of opening of an aperture, and whether a flash is used.

The digital signal processing unit may comprise: a photographing information obtaining unit configured to obtain the photographing information when the image is photographed, and configured to classify the obtained photographing information; a memory configured to store the classified photographing information; and a photographing information outputting unit configured to search the photographing information stored in the memory for photographing information satisfying a user's request and configured to output the photographing information satisfying the user's request.

The photographing information may include an accumulated photographing number for all photographs associated with each piece of the photographing information.

The photographing information outputting unit may be configured to provide a main menu having items corresponding the classified photographing information and configured to provide a sub-menu corresponding to the main menu, wherein the selection of a sub-menu selected by the user outputs photographing information satisfying the user's request.

In embodiments, a method of operating a digital image processing device is provided, the method comprising: generating photographing information used when an image is photographed; classifying and storing the photographing information; and searching the classified photographing information according to a user's request; and outputting the photographing information satisfying the user's request.

The classifying and storing may further comprise: classifying and storing the photographing information by an accumulated photographing number for all photographs, and an accumulated photographing number corresponding to each piece of the photographing information.

The searching may further comprise: providing a main menu having items corresponding to photographing information and a sub-menu corresponding to the main menu; and in response to a selection of a main menu and a sub-menu by a user, searching the photographing information for photographing information matching the main menu and the sub-menu selected by the user, and outputting the matching photographing information.

In embodiments, a method of operating a digital image processing device is provided, the method may comprise: reading lens information regarding a lens included in the digital image processing device; generating the lens information and photographing information used when an image is photographed; classifying and storing the photographing information; and searching the classified photographing information according to a user's request; and outputting the photographing information satisfying the user's request.

The reading may comprise: reading the lens information when the digital image processing device is initialized, wherein the lens is an exchangeable lens.

The photographing information may include the lens information and at least one of a date and time, an image size, a photographing mode, a sensitivity, an exposure time, a focal length, a numerical number of an opening of an aperture, and whether a flash is used.

The classifying and storing may comprise: classifying and storing the photographing information by an accumulated photographing number for all photographs, and an accumulated photographing number corresponding to each piece of the photographing information.

The photographing information may include at least one of a date and time when the image is photographed, a photographing mode, a sensitivity, an exposure time, a focal length, a numerical number of an opening of an aperture, whether a flash is used, and wherein the photographing information is recorded in a predetermined area.

The searching may further comprise: providing a main menu having items corresponding to the photographing information and a sub-menu corresponding to the main menu; and searching the photographing information for photographing information matching the main menu and the sub-menu selected by a user, and outputting the matching photographing information.

### BRIEF DESCRIPTION OF THE DRAWINGS

The above and other features and advantages of the present invention will become more apparent by describing in detail embodiments thereof with reference to the attached drawings in which:

FIG. 1 is a perspective view of an example of a digital image processing device according to an embodiment of the present invention;

FIG. 2 is a back view of the example of the digital image processing device illustrated in FIG. 1;

FIG. 3 is a block diagram of an example of an apparatus for providing photographing information in a digital image processing device according to an embodiment of the present invention;

FIG. 4 is a detailed block diagram of an example of a digital signal processing unit included in the an apparatus of FIG. 3 according to an embodiment of the present invention;

FIGS. 5A through 5D illustrate examples of photographing information provided by the apparatus of FIG. 3 according to an embodiment of the present invention;

FIG. 6 is a flowchart illustrating an example of a method of providing photographing information in a digital image processing device according to an embodiment of the present invention;

FIG. 7 is a flowchart illustrating operations of examples of obtaining, classifying, and storing the photographing information shown in FIG. 6 according to an embodiment of the present invention; and

FIG. 8 is a detailed flowchart illustrating an example of an operation of providing the photographing information according to a user's request shown in FIG. 6 according to an embodiment of the present invention.

### DETAILED DESCRIPTION OF THE INVENTION

Hereinafter, embodiments of the present invention will be described in detail with reference to the accompanying drawings.

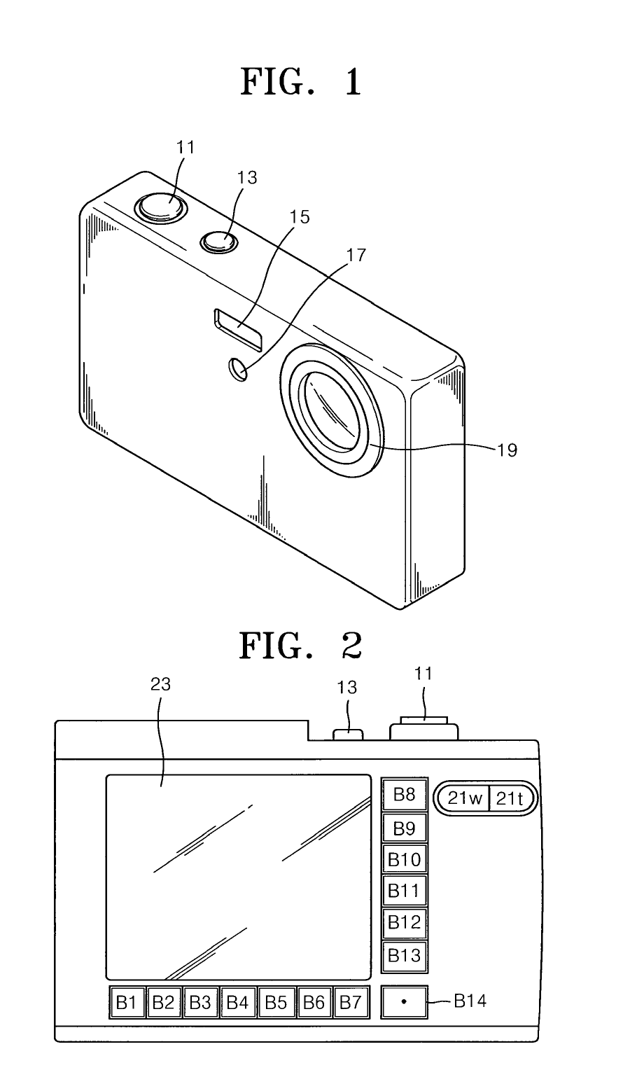

FIG. 1 is a perspective view of an example of a digital image processing device according to an embodiment of the present invention. Referring to FIG. 1, in embodiments, a shutter-release button 11 is used to open and close a shutter in order to expose a charge coupled device (CCD) to light for a predetermined amount of time and records an image in the CCD by appropriately exposing an object in cooperation with an aperture (not shown).

In embodiments, the shutter-release button 11 generates a first photographing signal and a second photographing signal according to a user input. Upon a first manipulation of the shutter-release button 11 into a half-depressed state, the digital image processing device adjusts a focus and the amount of light. In embodiments, when the digital image processing device is in focus, a green light is turned on in a display unit 23 (in FIG. 2). After the digital image processing device finishes focusing and adjusting the amount of light in response to first manipulation of the shutter-release button 11, the shutter-release button 11 is manipulated into a fully-depressed state so as to input the second photographing signal to proceed with photographing.

In embodiments, the power button 13 is manipulated in order to operate the digital image processing device by supplying power to the digital image processing device.

In embodiments, the flash 15 briefly provides a flash of bright light to an object for photographing in a dark environment. In embodiments, the flash 15 has flash modes such as auto flash, fill flash, flash off, red-eye reduction, slow sync, and the like.

In embodiments, the sub light 17 provides light to an object in order to allow the digital image processing device to quickly and accurately adjust a focus in an automatic manner in the conditions of insufficient light or night photographing.

In embodiments, the lens unit 19 optically processes light received from the object.

FIG. 2 is a back view of the digital image processing device illustrated in FIG. 1. Referring to FIG. 2, the digital image processing device includes a wide-angle zoom button 21w, a telephoto zoom button 21t, a display unit 23, and input buttons B1 through B14 having touch sensors or contact switches.

In embodiments, when the wide-angle zoom button 21w or the telephoto zoom button 21t is manipulated, the angle of view becomes wider or narrower. In particular, the wide-angle zoom button 21w or the telephoto zoom button 21t is manipulated in order to change the size of a selected exposure region. The size of the selected exposure region is increased upon manipulation of the wide-angle zoom button 21w, and the size of the selected exposure region decreases upon manipulation of the telephoto zoom button 21t.

In embodiments, the input buttons B1 through B14 are provided in a horizontal line and a vertical line of the display unit 23. In embodiments, the input buttons B1 through B14 have touch sensors, that can be used by the user to select an arbitrary item, e.g., color or brightness, from a main menu item or can be used to activate a sub menu icon included in a main menu icon, by moving up/down/left/right while touching the buttons B1 through B7 in the horizontal line or the buttons B8 through B14 in the vertical line.

In embodiments, when the input buttons B1 through B14 have contact switches, the user can execute a desired function by directly selecting a main menu icon and a sub menu icon thereof. In embodiments, a touch sensor input is more sensitive compared to a contact switch input, and thus the contact switch input requires a stronger touch compared to the touch sensor input.

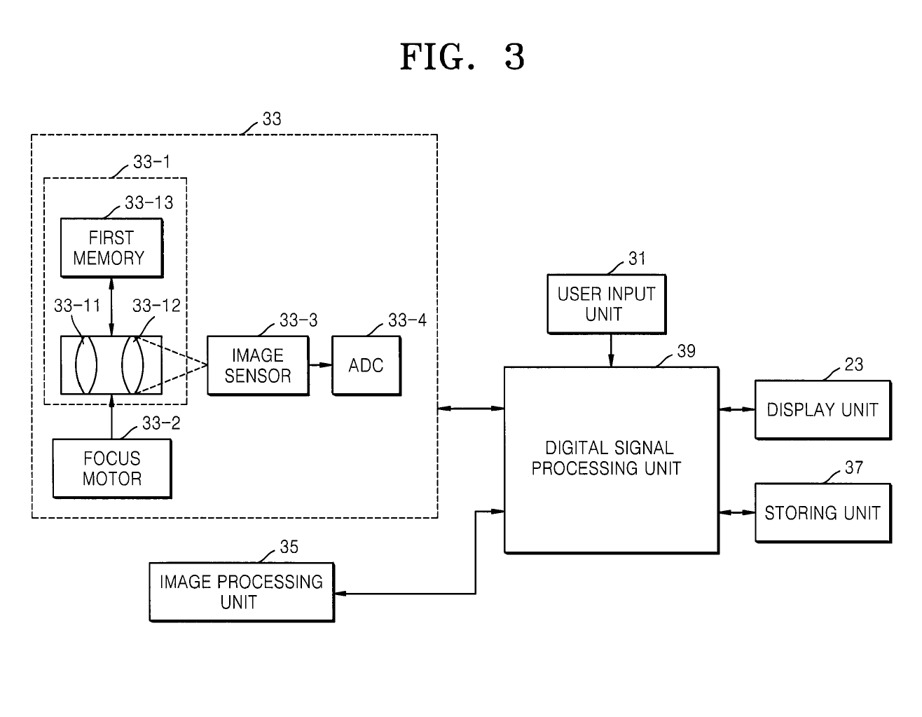

FIG. 3 is a block diagram of an example of an apparatus for providing photographing information in a digital image processing device according to an embodiment of the present invention. Referring to FIG. 3, the apparatus comprises a display unit 23, a user input unit 31, a photographing unit 33, an image processing unit 35, a storing unit 37, and a digital signal processing unit 39.

In embodiments, the user input unit 31 comprises the shutter-release button 11 that is used to open or close a shutter in order to expose a CCD to light for a predetermined amount of time, the power button 13 that is used to supply power, the wide-angle zoom button 21w and the telephoto zoom button 21t for increasing or reducing the angle of view, and the buttons B1 through B14 having touch sensors or contact switches and provided in a horizontal line and a vertical line of the display unit 23 so as to input text or select a menu/item.

In embodiments, the photographing unit 33 comprises a body tube 33-1 including a zoom lens 33-11, a focus lens 33-12, and a first memory 33-13, a focus motor 33-2, an image sensor 33-3, an analog-to-digital converter (ADC) 33-4, a shutter and an aperture that are not shown in the figures.

The shutter is used to adjust the amount of light for light exposure in cooperation with the aperture. In embodiments, the zoom lens 33-11 and the focus lens 33-12 optically process light received from an object. The aperture adjusts the amount of incident light according to the degree to which it is opened. The degree to which the aperture is opened is controlled by the digital signal processing unit 39.

In embodiments, the optical axis of the zoom lens 33-11 and the focus lens 33-12 is identical to a vertical line extending from an approximate center of a light receiving surface of the image sensor 33-3. In embodiments, the focus lens 33-12 vertically moves back and forth on the optical axis, and changes a focus point of an image formed on the light receiving surface of the image sensor 33-3 according to the location thereof. In embodiments, the location of the zoom lens 33-11 and the focus lens 33-12 is controlled by the digital signal processing unit 39 through the lens motor 33-2.

In embodiments, the first memory 33-13 stores information about exchangeable lenses of the digital image processing device. For example, the first memory 33-13 stores information about a type of a currently used lens, a focal distance, a maximum aperture f number, a position of an exit pupil, and an existence of an aperture ring. In embodiments, the digital signal processing unit 39 read lens information from the first memory 33-13 whenever the digital image processing device is initialized.

In embodiments, the image sensor 33-3 accumulates the amount of light through the zoom lens 33-11 and the focus lens 33-12, and outputs an image captured through the lens unit in synchronization with a vertical sync signal according to the accumulated amount of light. In embodiments, the digital image processing device can obtain an image by means of the image sensor 33-3 that converts light reflected from an object into an electric signal. In embodiments, a color filter is required to obtain a color image using the image sensor 33-3. A color filter array (CFA) filter (not shown) is widely used. The CFA passes light of a single color for each pixel, has a regularly arranged structure, and has various shapes according to an arrangement structure. In embodiments, the ADC 33-4 converts an analog image signal output from the image sensor 33-3 into a digital image signal.

In embodiments, the image processing unit 35 performs signal processing to allow an image signal converted into digitally converted RAW data to be displayed. In embodiments, the image processing unit 35 removes a black level of a dark current generated in the CCD and the CFA filter that are sensitive to a temperature variation. In embodiments, the image processing unit 35 performs gamma correction for encoding information so as to be appropriate for the nonlinearity of human vision. In embodiments, the image processing unit 35 performs color filter array (CFA) interpolation by interpolating a Bayer pattern implemented by RGRG lines and GBGB lines of gamma-corrected predetermined data into RGB lines. In embodiments, the image processing unit 35 converts the interpolated RGB signal into a YUV signal, performs edge compensation by filtering Y signals by using a high-pass filter and color correction by correcting color values of U and V signals by using a standard color coordinate system, and removes noise from the U and V signals. In embodiments, the image processing unit 35 then compresses and signal-processes the YUV signals from which noise has been removed, and generates an Exif file. The generated Exif file is displayed in the display unit 23 and is stored in the storing unit 37. In embodiments, the image processing unit 35 operates under the control of the digital signal processing unit 39.

In embodiments, the digital signal processing unit 39 receives the lens information about the currently used lens from the first memory 33-1 of the body tube 33-1, classifies and stores photographing information when an image is photographed, and searches for and outputs the classified photographing information according to a user's request.

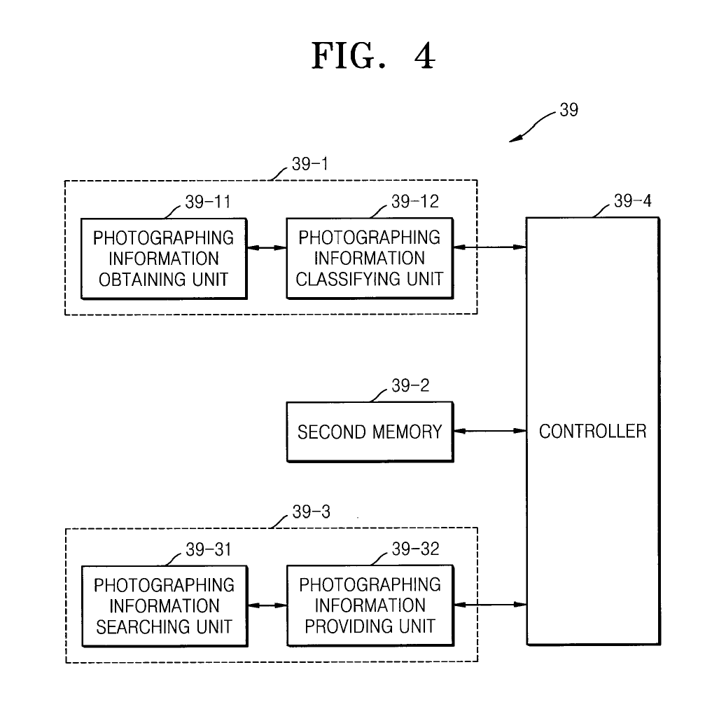

FIG. 4 is a detailed block diagram of an example of a digital signal processing unit 39 according to an embodiment of the present invention. Referring to FIG. 4, the digital signal processing unit 39 comprises a photographing information generating unit 39-1, a second memory 39-2, a photographing information outputting unit 39-3, and a controller 39-4. The photographing information generating unit 39-1 comprises a photographing information obtaining unit 39-11 and a photographing information classifying unit 39-12. The photographing information outputting unit 39-3 comprises a photographing information searching unit 39-31 and a photographing information providing unit 39-32.

The photographing information generating unit 39-1 obtains photographing information when the image is photographed under the control of the controller 39-4, and classifies the photographing information into a form of information that can be output. The photographing information generating unit 39-1 generates the photographing information when the image is photographed under the control of the controller 39-4.

The photographing information obtaining unit 39-11 obtains photographing information when the image is photographed. For example, the photographing information obtaining unit 39-11 receives the lens information from the first memory 33-13, and obtained detailed additional information such as a date and time when an image is photographed, which is recorded in a predetermined area when an image file is generated, an image size, a photographing mode, sensitivity, exposure, a focal length, a numerical number of opening of an aperture, whether a flash is used, and the like. In embodiments, the photographing information obtaining unit 39-11 obtains information about the photographing number by counting the number of generated image files.

When an image is photographed, an image file, for example an Exif file, is generated. The Exif file has a structure of markers including a start of image (SOI), application data (APP), a define quantization table (DQT), a define Huffman table (DHT), a start of frame (SOF), a start of scan (SOS), and an end of frame (EOI), and has compressed image data. The markers are referred to as headers. The APP area stores photographing information of the compressed image data.

In embodiments, the photographing information obtaining unit 39-11 obtains the photographing information that is to be recorded on the APP area of the Exif file, the lens information, and the photographing number information.

In embodiments, the photographing information classifying unit 39-12 classifies the photographing information that can be output by using the photographing information obtained by the photographing information obtaining unit 39-11. For example, the photographing information classifying unit 39-12 classifies the obtained photographing information into an accumulate number of all photographs, an accumulated photographing number according to a sensitivity setting, an accumulated photographing number according to photographing mode, a list of lenses that have been used, an accumulated photographing number of each lens, an accumulated photographing number according to exposure time, and the like. In embodiments, additional photographing information may be obtained and classified.

In embodiments, the second memory 39-2 stores the photographing information classified by the photographing information classifying unit 39-12 under the controller 39-4. In embodiments, the second memory 39-2 may store the photographing information classified by the photographing information classifying unit 39-12 or index the photographing information about photographed images and store the indexed photographing information. The photographing information stored in the second memory 39-2 may be updated whenever an image is photographed.

The photographing information outputting unit 39-3 searches for and outputs the photographing information requested by the second memory 39-2 according to a user's request to output the photographing information under the control of the controller 39-4.

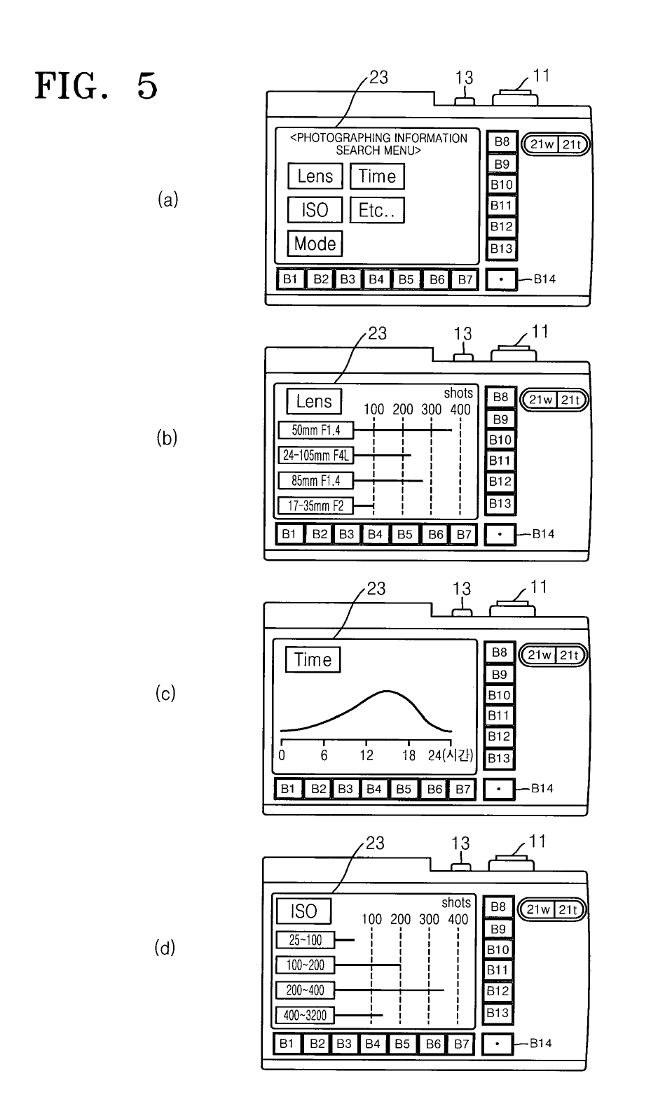

In embodiments, the photographing information searching unit 39-31 searches the second memory 39-2 in response to the user's request to output the photographing information. In embodiments, the photographing information searching unit 39-31 provides a main menu corresponding to each piece of photographing information and a sub-menu corresponding to the main menu so that a user can conveniently search for the photographing information. In embodiments, if the user inputs a signal via a predetermined key so as to search for the photographing information, the photographing information searching unit 39-31 controls the display unit 23 to display a main menu for searching for the photographing information, i.e., lenses, exposure time, sensitivity, a photographing mode, etc. so that the user can select the main menu with reference to FIG. 5A. In embodiments, if the user selects a predetermined main menu, the sub-menu corresponding to the selected main menu or the photographing information corresponding to the selected main menu is displayed on the display unit 23.

In embodiments, the photographing information providing unit 39-32 provides the photographing information found from the second memory 39-2 after the user selects the main menu. FIGS. 5B through 5D illustrate examples of photographing information provided by the apparatus of FIG. 3 according to embodiments of the present invention. Referring to FIG. 5B, in embodiments, when lenses are selected from the main menu shown in FIG. 5A, a list of lenses that have been used to photograph images up to now and an accumulated photographing number are illustrated. Referring to FIG. 5C, in embodiments, when time is selected from the main menu shown in FIG. 5A, an accumulated image photographing number according to exposure time is illustrated. Referring to FIG. 5D, in embodiments, when sensitivity is selected from the main menu shown in FIG. 5A, an accumulated image photographing number according to sensitivity is illustrated.

As described above, the user can become familiar with their photographing pattern by use of the present invention in which photographing information used when an image is photographed is stored, photographing information according to a user's request is searched for, and the matching photographing information is provided.

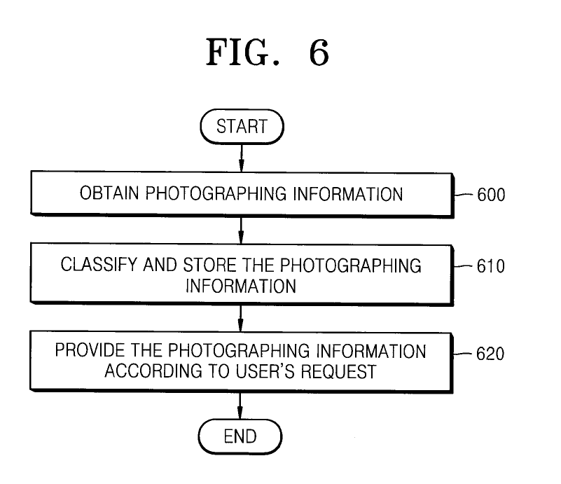

Hereinafter, an example of a method of providing photographing information in a digital image processing device according to the present invention will be described with reference to FIGS. 6 through 8. In embodiments, the method of providing photographing information of the present invention may be performed in the digital signal processing unit 39 with assistance from the peripheral constituents of a control device.

FIG. 6 is a flowchart illustrating an example of a method of providing photographing information in a digital image processing device according to an embodiment of the present invention. Referring to FIG. 6, in embodiments, when an image is photographed, the digital signal processing unit 39 obtains photographing information in operation 600, and classifies and stores the obtained photographing information in operation 610. In embodiments, the photographing information is generated by the digital image processing device. In embodiments, the digital image processing device may generate the photographing information using hardware and/or software.

In embodiments, the digital signal processing unit 39 provides the photographing information according to a user's request in operation 620.

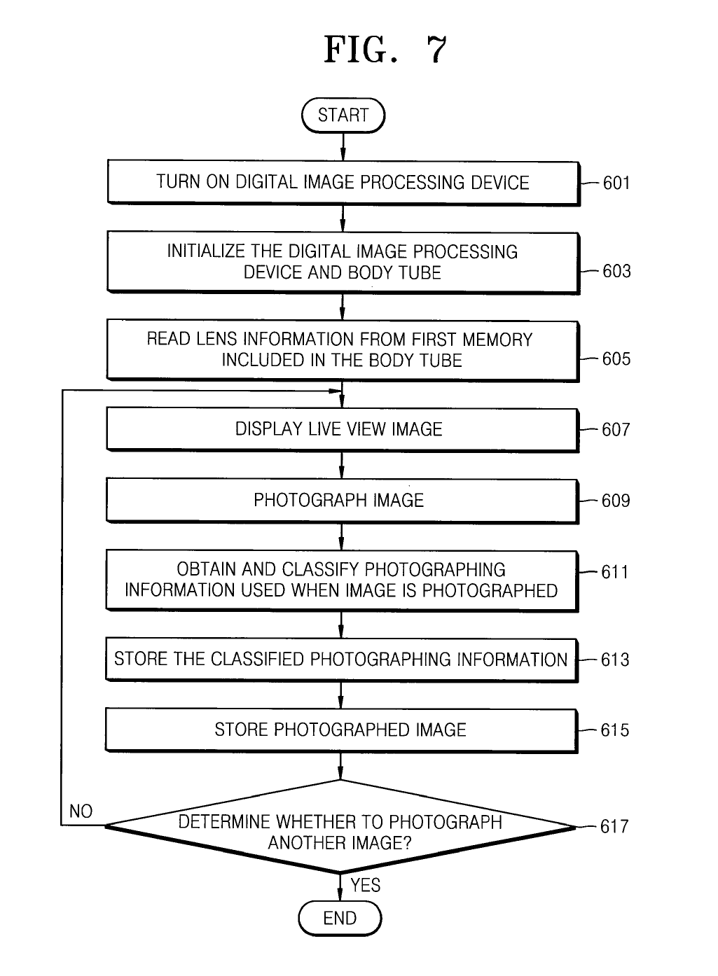

FIG. 7 is a flowchart illustrating examples of the detailed operations 600 and 610. Referring to FIG. 7, in embodiments, when a digital image processing device is turned on in operation 601, the digital signal processing unit 39 initializes the digital image processing device and the body tube 33-1 in operation 603.

In embodiments, when the body tube 33-1 is initialized, the digital signal processing unit 39 reads lens information from the first memory 33-13 included in the body tube 33-1 in operation 605. In embodiments, the first memory 33-13 stores the lens information of exchangeable lenses of the digital image processing device. For example, the first memory 33-13 stores information about a type of currently used lenses, a focal distance, a maximum aperture f number, a position of an exit pupil, and an existence of an aperture ring. In embodiments, the digital signal processing unit 39 reads the lens information from the first memory 33-13 whenever the body tube 33-1 is initialized.

In embodiments, after the lens information is read, the digital signal processing unit 39 displays a live view image in operation 607, receives a signal input by the shutter-release button 11 from a user, and photographs an image in operation 609.

In embodiments, when an image is photographed, the digital signal processing unit 39 obtains and classifies photographing information used when the image is photographed in operation 611. In embodiments, the photographing information includes the lens information obtained from the first memory 33-13, and detailed additional information including a date and time when an image is photographed, which is recorded in a predetermined area when an image file is generated, an image size, a photographing mode, sensitivity, exposure, a focal length, a numerical number of an opening of an aperture, whether to use flash, and the like. In embodiments, the digital signal processing unit 39 obtains information about the photographing number by counting the number of generated image files. The digital signal processing unit 39 classifies the photographing information that can be output by using the obtained photographed information. For example, the digital signal processing unit 39 classifies the obtained photographing information into an accumulated photographing number of all photographs, an accumulated photographing number according to a sensitivity setting, an accumulated photographing number according to photographing mode, a list of lenses that have been used, an accumulated photographing number of each lens, an accumulated photographing number according to exposure time, and the like, but the present invention is not limited thereto.

In embodiments, when the photographing information is completely classified, the digital signal processing unit 39 stores the classified photographing information in operation 613. The digital signal processing unit 39 may store the classified photographing information or index the photographing information regarding photographed images and store the indexed photographing information. The digital signal processing unit 39 may update the stored photographing information whenever the image is photographed.

In embodiments, when the classified photographing information is completely stored, the digital signal processing unit 39 stores photographed image files in the storage unit 37 in operation 615. In embodiments, when an image is photographed, an image file, i.e. generally an Exif file, is generated. The Exif file has a structure of markers including SOI, APP, DQT, DHT, SOF, SOS, and EOI, and has compressed image data. The markers are referred to as headers. In embodiments, the APP area stores photographing information of the compressed image data.

In embodiments, the digital signal processing unit 39 determines whether to photograph another image in operation 617, and proceeds to operation 607 to photograph an image, obtain, classify, and store photographing information.

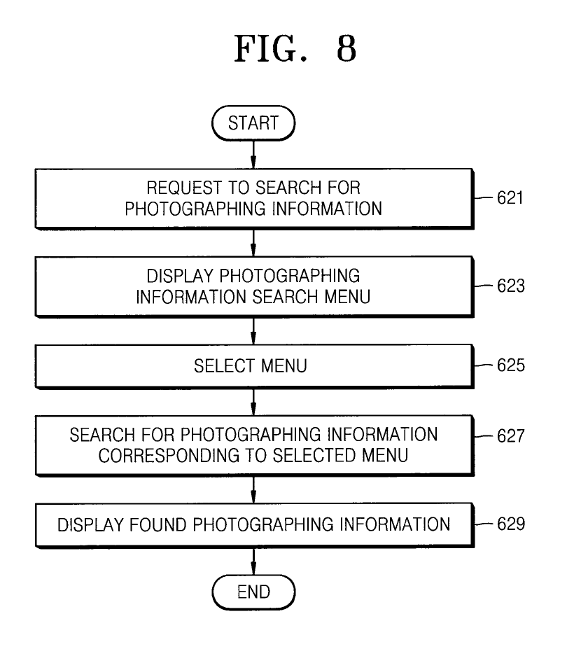

FIG. 8 is a detailed flowchart illustrating embodiments of operation 620 according to an embodiment of the present invention. Referring to FIG. 8, in embodiments, if the user inputs a signal requesting to search for the photographing information in operation 612, the digital signal processing unit 39 displays a menu for providing the photographing information in operation 623. The digital signal processing unit 39 provides a main menu corresponding to the photographing information and a sub-menu corresponding to the main menu so that the user can conveniently search for the photographing information. In embodiments, if the user inputs an optional key so as to search for the photographing information, the digital signal processing unit 39 controls the display unit 23 to display a main menu for searching for the photographing information, i.e., lenses, exposure time, sensitivity, a photographing mode, and the like so that the user can select the main menu as shown in FIG. 5A.

In embodiments, if the user selects an optional main menu in operation 625, the digital signal processing unit 39 searches for the sub-menu corresponding to the selected main menu or the photographing information corresponding to the selected main menu in operation 627, and displays the photographing information on the display unit 23 in operation 629. In embodiments, the digital signal processing unit 39 searches for and displays the photographing information corresponding to the menu selected by the user. FIGS. 5B through 5D illustrate examples of the photographing information found according to the user's request. Referring to FIG. 5B, when lens is selected from the main menu shown in FIG. 5A, a list of lenses that have been used to photograph images up to now and an accumulated photographing number are illustrated. Referring to FIG. 5C, when time is selected from the main menu shown in FIG. 5A, an accumulated image photographing number according to exposure time is illustrated. Referring to FIG. 5D, when ISO is selected from the main menu shown in FIG. 5A, an accumulated image photographing number according to sensitivity is illustrated.

As described above, the user can easily become familiar with their own photographing pattern by use of the present invention in which photographing information used when an image is photographed is stored, photographing information according to a user's request is searched for, and the matched photographing information is provided.

As described above, the present invention stores photographing information when an image is photographed, searches for the photographing information according to a user's request, and provides a user with the photographing information, thereby allowing a user to easily become familiar with their own photographing pattern. The user may improve their photographing skills by using this information.

Embodiments comprise a computer readable medium encoded with computer-executable instructions to perform a method. The computer readable medium includes RAM memory, flash memory, ROM memory, EPROM memory, EEPROM memory, registers, a hard disk, a removable disk, a CD-ROM, or other forms of computer readable media known in the art.

For convenience, in the description above, the functionality described has been divided into a number of units; however, the number of units may vary and the functionality described above may be differently divided among the units, or the functionality described above may be implemented without units.

The various illustrative units described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

While embodiments of the present invention has been particularly shown and described with reference to embodiments thereof, it will be understood by one of ordinary skill in the art that various changes in form and detail may be made therein without departing from the spirit and scope of the present invention as defined by the following claims.

What is claimed is:

1. An apparatus comprising:
a digital signal processing unit configured to:
classify and store photographing information with a photographed image,
search the photographing information according to a user's request, and
output the photographing information satisfying the user's request, wherein the photographing information is generated by the apparatus and indicative of the conditions under which the photographed image was captured.

2. The apparatus of claim 1, wherein the photographing information includes at least one of: a date and time when an image is photographed, an image size, a photographing mode, a sensitivity, an exposure time, a focal length, a numerical number of an opening of an aperture, and whether a flash is used, and wherein the photographing information is recorded in a predetermined area.

3. The apparatus of claim 2, wherein the digital signal processing unit comprises:
a photographing information obtaining unit configured to obtain the photographing information when the image is photographed, and classify the obtained information;
a memory configured to store the classified photographing information; and
a photographing information outputting unit configured to search the classified photographing information stored in the memory for photographing information satisfying a user's request and output the photographing information satisfying the user's request.

4. The apparatus of claim 3, wherein the information obtaining unit is configured to count the number of accumulated photographs taken and configured to include the accumulated number of photographs with the obtained information.

5. The apparatus of claim 4, wherein the information outputting unit is configured to provide a main menu having items corresponding to the classified photographing information and provide a sub-menu corresponding to a main menu item, wherein the selection of a sub-menu by the user outputs information satisfying the user's request.

6. An apparatus comprising:
a photographing unit configured to store information regarding exchangeable lenses; and
a digital signal processing unit configured to
receive the information regarding exchangeable lenses from the photographing unit,
obtain lens information and photographing information when an image is photographed;
classify the photographing information,
search the photographing information according to a user's request, and
output the photographing information matching the user's request.

7. The apparatus of claim 6, wherein the photographing information further includes the lens information and at least one of a date and time when an image is photographed, an image size, a photographing mode, sensitivity, exposure time, a focal length, a numerical number of opening of an aperture, and whether a flash is used.

8. The apparatus of claim 7, wherein the digital signal processing unit comprises:
a photographing information obtaining unit configured to obtain the photographing information when the image is photographed, and classify the obtained photographing information;
a memory configured to store the classified photographing information; and
a photographing information outputting unit configured to search the photographing information stored in the memory for photographing information satisfying a user's request and output the photographing information satisfying the user's request.

9. The apparatus of claim 8, wherein the photographing information includes an accumulated photographing number for all photographs associated with each piece of the photographing information.

10. The apparatus of claim 9, wherein the photographing information outputting unit is configured to provide a main menu having items corresponding the classified photographing information and provide a sub-menu corresponding to the main menu, wherein the selection of a sub-menu selected by the user outputs photographing information satisfying the user's request.

11. A method of operating a digital image processing device, the method comprising:
obtaining photographing information used when an image is photographed;
classifying and storing the photographing information;
searching the classified photographing information according to a user's request; and
outputting the photographing information satisfying the user's request.

12. The method of claim 11, wherein the photographing information includes at least one of a date and time when the image is photographed, a photographing mode, a sensitivity, an exposure time, a focal length, a numerical number of an opening of an aperture, whether a flash is used, and wherein the photographing information is recorded in a predetermined area.

13. The method of claim 11, wherein classifying and storing further comprise: classifying and storing the photographing information by an accumulated photographing number for all photographs, and an accumulated photographing number corresponding to the photographing information.

14. The method of claim 11, wherein the searching further comprises:
providing a main menu having items corresponding to photographing information and a sub-menu corresponding to the main menu; and
in response to a selection of a main menu and a sub-menu by a user, searching the photographing information for photographing information matching the main menu and the sub-menu selected by the user, and outputting the matching photographing information.

15. A method of operating a digital image processing device, the method comprising:
reading lens information regarding a lens included in the digital image processing device;
obtaining the lens information and photographing information used when an image is photographed;
classifying and storing the photographing information; and
searching the classified photographing information according to a user's request; and
outputting the photographing information satisfying the user's request.

16. The method of claim 15, wherein reading comprises reading the lens information when the digital image processing device is initialized, wherein the lens is an exchangeable lens.

17. The method of claim 16, wherein the photographing information includes the lens information and at least one of a date and time, an image size, a photographing mode, a sensitivity, an exposure time, a focal length, a numerical number of an opening of an aperture, and whether a flash is used.

18. The method of claim 17, wherein classifying and storing comprises classifying and storing the photographing information by an accumulated photographing number for all photographs, and an accumulated photographing number corresponding to each piece of the photographing information.

19. The method of claim 18, wherein the searching further comprises:
providing a main menu having items corresponding to the photographing information and a sub-menu corresponding to the main menu; and
searching the photographing information for photographing information matching the main menu and the sub-menu selected by a user, and outputting the matching photographing information.
